(19) United States
(12) Patent Application Publication
(10) Pub. No.: US 2018/0374448 A1
(43) Pub. Date: Dec. 27, 2018

(54) ELECTRONIC DEVICE FOR DETECTING ACCESSORY DEVICE AND METHOD FOR OPERATING SAME

(71) Applicant: SAMSUNG ELECTRONICS CO., LTD., Suwon-si, Gyeonggi-do (KR)

(72) Inventors: Hyeyeon JEONG, Seoul (KR); Dae-Ung JEONG, Suwon-si, Gyeonggi-do (KR); Jung-Hoon PARK, Incheon (KR)

(21) Appl. No.: 15/774,761

(22) PCT Filed: Oct. 24, 2016
(86) PCT No.: PCT/KR2016/011978

§ 371 Date: May 9, 2018

(30) Foreign Application Priority Data
Nov. 9, 2015 (KR) 10-2015-0156775

(51) Int. Cl. G09G 5/00; G06F 3/044; G06F 3/041; G06F 21/44; G06F 1/16

(52) U.S. Cl. CPC G09G 5/006; G06F 3/044; G06F 3/0416; G09G 5/38; G06F 1/1656; G06F 2203/04108; G06F 21/44

(57) ABSTRACT

The present invention relates to an electronic device for detecting an accessory device and a method for operating the same, the electronic device comprising: an external housing including a first surface facing a first direction, a second surface facing a second direction opposite to the first direction, and a side surface surrounding at least a part of the space between the first surface and the second surface; a user interface exposed through at least a part of the first surface, the second surface, and/or the side surface of the housing; a communication circuit disposed inside the housing; a first sensor disposed inside the housing; a conductive member electrically connected to the first sensor and disposed adjacent to at least a part of the second surface and/or the side surface of the housing; a processor electrically connected to the communication circuit, the user interface, and the first sensor; and a memory electrically connected to the processor, wherein the memory may store instructions which, when executed, cause the processor to: detect whether the accessory device configured to be detachably mounted on the second surface of the housing comes into contact with or approaches the conductive member, using the first sensor so as to generate a first signal; compare the first signal with at least one threshold value; perform at least one action through the communication circuit and/or the user interface, on the basis of the result of the comparison. Other embodiments are also applicable.

### FIELD OF THE INVENTION

The present invention relates to an electronic device for detecting an accessory device mounted/non-mounted on the electronic device, and a method for operating the same.

### BACKGROUND

A display device of an electronic device recently released is a full touch screen. To prevent the full touch screen from being damaged due to an external impact and utilize various supplementary functions, users can use an accessory device, etc. that is mounted to surround a part or whole of the electronic device. The accessory device can be mounted on the electronic device with having a connector, a hall sensor, etc. The electronic device can identify whether the accessory device is mounted/non-mounted, by using the connector, the hall sensor, etc. of the accessory device.

### DETAILED DESCRIPTION OF THE INVENTION

### Technological Problem

A method for detecting the mounting/non-mounting of an accessory device by a connector, a hall sensor, etc. in an electronic device can cause a problem in which parts addition results in an increase of a manufacturing cost of the accessory device and electronic device. The hall sensor has magnetic properties, so a problem of having to change a disposition of parts affected by the magnetic properties in the electronic device can occur.

Various embodiments of the disclosure may provide an electronic device capable of detecting the mounting/non-mounting of an accessory device by using a change of capacitance detected in the electronic device, and a method for operating the same.

### Means for Solving Problem

An electronic device detecting an accessory device according to an embodiment of the disclosure may include an external housing including a first surface facing a first direction, a second surface facing a second direction opposite to the first direction, and a side surface surrounding at least a part of the space between the first surface and the second surface, a user interface exposed through at least a part of the first surface, the second surface, and/or the side surface of the housing, a communication circuit disposed inside the housing, a first sensor disposed inside the housing, a conductive member electrically connected to the first sensor, and disposed adjacent to at least a part of the second surface and/or the side surface of the housing, a processor electrically connected to the communication circuit, the user interface, and the first sensor, and a memory electrically connected to the processor, wherein the memory may store instructions which, when executed, cause the processor to detect whether an accessory device configured to be detachably mounted on the second surface of the housing comes into contact with or approaches the conductive member, by using the first sensor, so as to generate a first signal, compare the first signal with at least one threshold value, and perform at least one action through the communication circuit and/or the user interface, on the basis of the result of the comparison.

An operation method detecting an accessory device according to an embodiment of the disclosure may include detecting a change of capacitance, performing the authentication of the accessory device in response to the detected capacitance being a value exceeding a first threshold value, and controlling screen data in response to a success of the authentication of the accessory device.

An electronic device detecting an accessory device according to an embodiment of the disclosure may include a sensor unit detecting a change of capacitance, and a controller performing the authentication of the accessory device in response to the changed capacitance being a value exceeding the first threshold value, and controlling screen data in response to a success of the authentication of the accessory device.

### Effects of the Invention

An electronic device of various embodiments of the disclosure may detect a change of capacitance, to detect the mounting/non-mounting of an accessory device, without mounting an additional part.

### BRIEF DESCRIPTION OF THE DRAWINGS

FIG. 1 is a diagram illustrating a network environment including an electronic device of an embodiment of the disclosure.

FIG. 2 is a block diagram illustrating a main construction of an electronic device of an embodiment of the disclosure.

FIG. 3 is a block diagram illustrating a program module of an embodiment of the disclosure.

FIG. 4 is a block diagram illustrating a main construction of an electronic device detecting an accessory device of an embodiment of the disclosure.

FIG. 5 is a diagram for explaining a first threshold value and a second threshold value of an embodiment of the disclosure.

FIG. 6 is a flowchart for explaining a method of detecting an accessory device of an embodiment of the disclosure.

FIG. 7 is a flowchart for explaining a method for performing the authentication of an accessory device of an embodiment of the disclosure.

FIG. 8 is a screen example diagram for explaining the forms of an accessory device and an electronic device of an embodiment of the disclosure.

FIG. 9 is a screen example diagram for explaining a state of an electronic device on which an accessory device of an embodiment of the disclosure is mounted.

FIG. 10 is a screen example diagram for explaining the forms of an accessory device and an electronic device of an embodiment of the disclosure.

FIG. 11 is a screen example diagram for explaining a position of a sensor detecting capacitance, provided in an electronic device of an embodiment of the disclosure.

FIG. 12 is a screen example diagram for explaining a position of a dielectric substance provided in an accessory device of an embodiment of the disclosure.

FIG. 13 is a screen example diagram for explaining a screen configuration of an electronic device at mounting of an accessory device of an embodiment of the disclosure.

FIG. 14 is a screen example diagram for explaining a screen configuration of an accessory device at mounting of the accessory device of an embodiment of the disclosure.

### BEST MODE FOR EMBODIMENT OF THE INVENTION

Various embodiments of the present disclosure are described in greater detail with reference to the accompanying drawings. The same or similar components may be designated by the same or similar reference numerals although they are illustrated in different drawings. Detailed descriptions of constructions or processes known in the art may be omitted to avoid obscuring the subject matter of the present disclosure. The terms used herein are defined in consideration of functions of the present disclosure and may vary depending on a user's or an operator's intention and usage. Therefore, the terms used herein should be understood based on the descriptions made herein. It is to be understood that the singular forms “a,” “an,” and “the” also include plural referents unless the context clearly dictates otherwise. In the present disclosure, an expression such as “A or B,” “at least one of A and B” or “one or more of A and B” may include all possible combinations of the listed items. Expressions such as “first,” “second,” “primarily,” or “secondary,” as used herein, may represent various elements regardless of order and/or importance, and do not limit the corresponding elements. The expressions may be used for distinguishing one element from another element. When it is described that an element (such as a first element) is operatively or communicatively “coupled to” or “connected to” another element (such as a second element), the element may be directly connected to the other element or may be connected through another element (such as a third element).

The expression “configured (or set) to”, as used in the present disclosure, may be used interchangeably with, for example, “suitable for,” “having the capacity to,” “designed to,” “adapted to,” “made to,” or “capable of”, according to the situation. The term “configured (or set) to” does not only refer to “specifically designed to” in hardware. Alternatively, in some situations, the expression “apparatus configured to” may refer to a situation in which the apparatus “may” operate together with another apparatus or component. The phrase “a processor configured (or set) to perform A, B, and C” may be a dedicated processor, a general-purpose processor (such as a central processing (CPU) or an application processor (AP)) that may perform a corresponding operation by executing at least one software program stored in a dedicated processor (such as an embedded processor) for performing a corresponding operation or in a memory device.

An electronic device, according to an embodiment of the present disclosure, may be for example, at least one of a smart phone, a tablet PC, a mobile phone, a video phone, an e-book reader, a desktop PC, a laptop PC, a notebook computer, a workstation, a server, a PDA, a portable multimedia player (PMP), an MPEG 3 (MP3) player, medical equipment, a camera, and a wearable device, and the like, but is not limited thereto. The wearable device may include at least one of an accessory type (e.g., a watch, a ring, a bracelet, an ankle bracelet, a necklace, eyeglasses, a contact lens, or a head-mounted-device (HMD)), a fabric or clothing embedded type (e.g., electronic garments), a body attachable type (e.g., a skin pad or a tattoo), and an implantable circuit, and the like, but is not limited thereto. The electronic device may be at least one of, for example, a television, a digital versatile disc (DVD) player, an audio device, a refrigerator, an air-conditioner, a cleaner, an oven, a microwave oven, a washing machine, an air cleaner, a set-top box, a home automation control panel, a security control panel, a media box, an electronic dictionary, an electronic key, a camcorder, and an electronic frame, and the like, but is not limited thereto.

In an embodiment of the present disclosure, the electronic device may be at least one of various medical devices (such as, various portable medical measuring devices (a blood sugar level measuring device, a heartbeat measuring device, a blood pressure measuring device, or a body temperature measuring device), a magnetic resonance angiography (MRA) device, a magnetic resonance imaging (MRI) device, a computed tomography (CT) device, a scanning machine, and an ultrasonic wave device), a navigation device, a global navigation satellite system (GNSS), an event data recorder (EDR), a flight data recorder (FDR), a vehicle infotainment device, electronic equipment for a ship (such as, a navigation device for a ship and a gyro compass), avionics, a security device, a head unit for a vehicle, an industrial or home robot, a drone, an automated teller machine (ATM), a point of sales (POS) device, and an Internet of things (IoT) device (e.g., a light bulb, various sensors, a sprinkler device, a fire alarm, a thermostat, a street light, a toaster, sports equipment, a hot water tank, a heater, and a boiler), and the like, but is not limited thereto. According to an embodiment of the present disclosure, the electronic device may be at least one of a portion of furniture, building/construction or vehicle, an electronic board, an electronic signature receiving device, a projector, and various measuring devices (e.g., water supply, electricity, gas, or electric wave measuring device), and the like, but is not limited thereto. An electronic device may be a flexible electronic device or a combination of two or more of the foregoing various devices. An electronic device is not limited to the foregoing devices, and may be embodied as a newly developed electronic device. The term “user”, as used herein, may refer to a person using an electronic device or a device using an electronic device (e.g., an artificial intelligence electronic device).

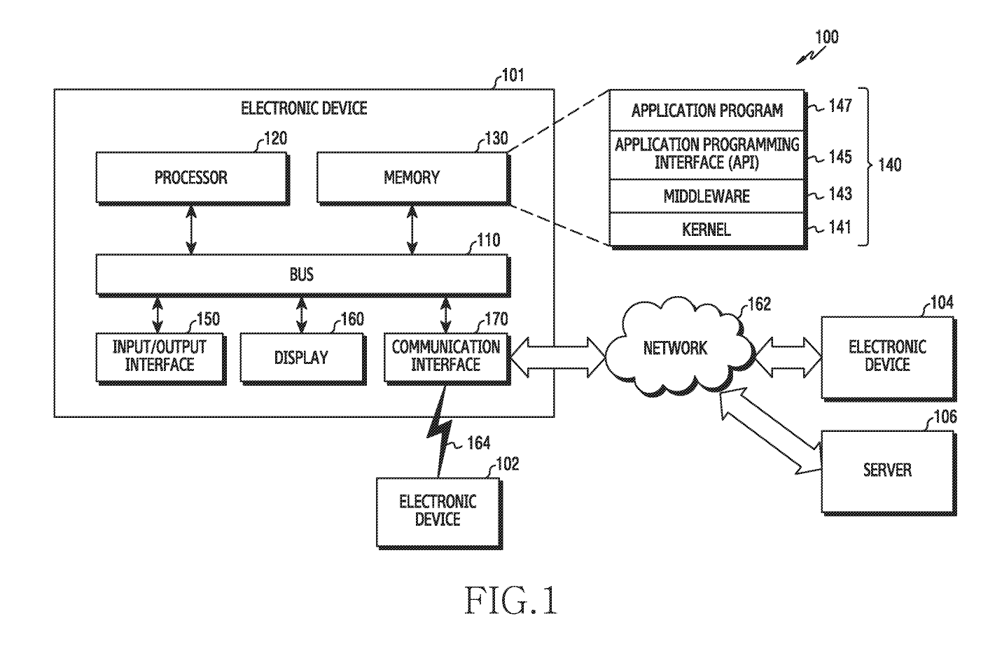

FIG. 1 is a block diagram of an electronic device in a system (100), according to an embodiment of the present disclosure. The electronic device 101 includes a bus 110, a processor 120, a memory 130, an input/output interface 150, a display 160, and a communication interface 170. The electronic device 101 may be provided without at least one of the components, or may include at least one additional component. The bus 110 may include a circuit for connecting the components 120 through 170 and delivering communication signals (e.g., control messages or data) therebetween. The processor 120 may include one or more of a CPU, an AP, and a communication processor (CP). The processor 120, for example, may perform an operation or data processing with respect to control and/or communication of at least another component of the electronic device 101.

The memory 130 may include a volatile and/or nonvolatile memory. The memory 130, for example, may store commands or data relating to at least another component of the electronic device 101. According to an embodiment of the present disclosure, the memory 130 may store software and/or a program 140. The program 140 includes, for example, a kernel 141, middleware 143, an application programming interface (API) 145, and/or an application program (or applications) 147. At least part of the kernel 141, the middleware 143, or the API 145 may be referred to as an operating system (OS). The kernel 141 may control or manage system resources (e.g., the bus 110, the processor 120, or the memory 130) used for performing operations or functions implemented by the other programs (e.g., the middleware 143, the API 145, or the applications 147). Additionally, the kernel 141 may provide an interface for controlling or managing system resources by accessing an individual component of the electronic device 101 from the middleware 143, the API 145, or the applications 147.

The middleware 143, for example, may serve an intermediary role for exchanging data between the API 145 or the applications 147 and the kernel 141 through communication. Additionally, the middleware 143 may process one or more job requests received from the applications 147, based on their priority. The middleware 143 may assign a priority for using a system resource (e.g., the bus 110, the processor 120, or the memory 130) of the electronic device 101 to at least one of the applications 147, and process the one or more job requests. The API 145, as an interface through which the applications 147 controls a function provided from the kernel 141 or the middleware 143, may include, for example, at least one interface or function (e.g., an instruction) for file control, window control, image processing, or character control. The input/output interface 150, for example, may deliver commands or data input from a user or another external device to other component(s) of the electronic device 101, or output commands or data input from the other component(s) of the electronic device 101 to the user or another external device.

The display 160, for example, may include a liquid crystal display (LCD), a light emitting diode (LED) display, an organic light emitting diode (OLED) display, a microelectromechanical systems (MEMS) display, or an electronic paper display, and the like, but is not limited thereto. The display 160, for example, may display various content (e.g., texts, images, videos, icons, and/or symbols) to the user. The display 160 may include a touch screen, for example, and receive touch, gesture, proximity, or hovering inputs by using an electronic pen or a user's body part. The communication interface 170, for example, may set communications between the electronic device 101 and an external device (e.g., a first external electronic device 102, a second external electronic device 104, or a server 106. The communication interface 170 may communicate with the second external electronic device 104 or the server 106 over a network 162 through wireless communication or wired communication.

The wireless communication, for example, may include cellular communication using at least one of long term evolution (LTE), LTE-advanced (LTE-A), code division multiple access (CDMA), wideband CDMA (WCDMA), universal mobile telecommunications system (UNITS), wireless broadband (WiBro), or global system for mobile communications (GSM). The wireless communication may include, for example, at least one of wireless fidelity (Wi-Fi), light fidelity (Li-Fi), Bluetooth™, Bluetooth™ low energy (BLE), Zigbee, near field communication (NFC), magnetic secure transmission, radio frequency (RF), and body area network (BAN). The wireless communication may include GNSS. The GNSS may include, for example, global positioning system (GPS), global navigation satellite system (GLONASS), Beidou navigation satellite system (Beidou), or Galileo (the European global satellite-based navigation system). Hereafter, the term GPS may be interchangeably used with the term GNSS. The wired communication, for example, may include at least one of universal serial bus (USB), high definition multimedia interface (HDMI), recommended standard 232 (RS-232), power line communications, and plain old telephone service (POTS). The network 162 may include a telecommunications network, for example, at least one of a computer network (e.g., LAN or WAN), the Internet, and a telephone network.

Each of the first and second external electronic devices 102 and 104 may be of the same type or of a different type from that of the electronic device 101. According to an embodiment of the present disclosure, all or part of operations executed in the electronic device 101 may be executed by another electronic device or a plurality of electronic devices (e.g., the electronic device 102 or 104, or the server 106). To perform a function or service automatically or by request, instead of performing the function or the service by the electronic device 101, the electronic device 101 may request at least part of a function relating thereto from the electronic device 102 or 104, or the server 106. The electronic device 102 or 104, or the server 106 may perform the requested function or an additional function and send its result to the electronic device 101. The electronic device 101 may provide the requested function or service by processing the received result. In doing so, for example, cloud computing, distributed computing, or client-server computing techniques may be used.

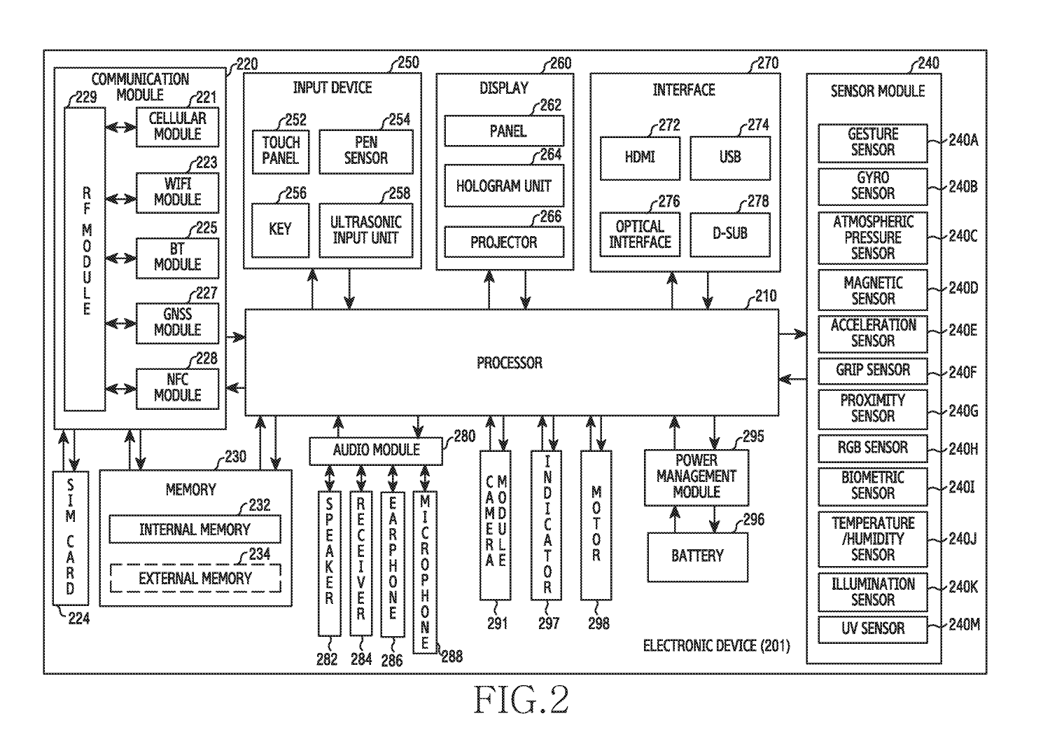

FIG. 2 is a block diagram of an electronic device, according to an embodiment of the present disclosure. The electronic device 201, for example, may include all or part of the above-described electronic device 101 of FIG. 1. The electronic device 201 includes one or more processors (e.g., an AP) 210, a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298. The processor 210, for example, may control a plurality of hardware or software components connected to the processor 210, and also may perform various data processing and operations by executing an OS or an application program. The processor 210 may be implemented with a system on chip (SoC), for example. The processor 210 may further include a graphic processing unit (GPU) and/or an image signal processor. The processor 210 may include at least part (e.g., a cellular module 221) of the components illustrated in FIG. 2. The processor 210 may load commands or data received from at least one other component (e.g., a nonvolatile memory) into a volatile memory, process the commands, and store various data in the nonvolatile memory.

The communication module 220 may have the same or similar configuration as the communication interface 170 of FIG. 1. The communication module 220 may include, such as, the cellular module 221, a Wi-Fi module 223, a Bluetooth™ (BT) module 225, a GNSS module 227, an NFC module 228, and an RF module 229. The cellular module 221, for example, may provide voice call, video call, short message service (SMS), or Internet service through a communication network. The cellular module 221 may identify and authenticate the electronic device 201 in a communication network by using the SIM 224. The cellular module 221 may perform at least part of a function that the processor 210 provides. The cellular module 221 may further include a CP. At least some (e.g., two or more) of the cellular module 221, the Wi-Fi module 223, the BT module 225, the GNSS module 227, and the NFC module 228 may be included in one integrated circuit (IC) or an IC package. The RF module 229, for example, may transmit/receive a communication signal (e.g., an RF signal). The RF module 229, for example, may include a transceiver, a power amp module (PAM), a frequency filter, a low noise amplifier (LNA), or an antenna. At least one of the cellular module 221, the Wi-Fi module 223, the BT module 225, the GNSS module 227, and the NFC module 228 may transmit/receive an RF signal through an additional RF module. The SIM 224, for example, may include a card or an embedded SIM, and also may contain unique identification information (e.g., an integrated circuit card identifier (ICCID)) or subscriber information (e.g., an international mobile subscriber identity (IMSI)).

The memory 230 (e.g., the memory 130) may include at least one of an internal memory 232 or an external memory 234. The internal memory 232 may include at least one of, for example, a volatile memory (e.g., dynamic RAM (DRAM), static RAM (SRAM), or synchronous dynamic RAM (SDRAM)), and a non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory, hard drive, and solid state drive (SSD)). The external memory 234 may include flash drive, for example, compact flash (CF), secure digital (SD), micro SD, mini SD, extreme digital (xD), multi-media card (MMC), or memory stick. The external memory 234 may be functionally or physically connected to the electronic device 201 through various interfaces.

The sensor module 240 may, for example, measure physical quantities or detect an operating state of the electronic device 201, and convert the measured or detected information into electrical signals. The sensor module 240 includes at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a red, green, blue (RGB) sensor). The sensor module 240 may also include an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling at least one sensor therein. The electronic device, as part of the processor 210 or individually, may further include a processor configured to control the sensor module 240 and control the sensor module 240 while the processor 210 is sleeping.

The input device 250, for example, may include at least one of a touch panel 252, a (digital) pen sensor 254, a key 256, and an ultrasonic input device 258. The touch panel 252 may use at least one of, for example, capacitive, resistive, infrared, and ultrasonic methods. Additionally, the touch panel 252 may further include a control circuit. The touch panel 252 may further include a tactile layer to provide a tactile response to a user. The (digital) pen sensor 254 may include, for example, part of a touch panel or a sheet for recognition. The key 256 may include, for example, a physical button, a touch key, an optical key, or a keypad. The ultrasonic input device 258 may detect ultrasonic waves from a microphone 288 and check data corresponding to the detected ultrasonic waves.

The display 260 (e.g., the display 160) may include at least one of a panel 262, a hologram device 264, a projector 266, and/or a control circuit for controlling them. The panel 262 may be flexible, transparent, or wearable, for example. The panel 262 and the touch panel 252 may be configured with one or more modules. The panel 262 may include a pressure sensor (or a force sensor) for measuring a pressure of the user touch. The pressure sensor may be integrated with the touch panel 252, or include one or more sensors separately from the touch panel 252. The hologram device 264 may show three-dimensional images in the air by using the interference of light. The projector 266 may display an image by projecting light on a screen. The screen, for example, may be placed inside or outside the electronic device 201. The interface 270, for example, may include an HDMI 272, a USB 274, an optical interface 276, or a D-subminiature (D-sub) 278. The interface 270 may be included in, for example, the communication interface 170 of FIG. 1. Additionally or alternately, the interface 270 may include a mobile high-definition link (MHL) interface, a SD card/MMC interface, or an infrared data association (IrDA) standard interface.

The audio module 280, for example, may convert sounds into electrical signals and convert electrical signals into sounds. At least some components of the audio module 280 may be included in, for example the input/output interface 150 of FIG. 1. The audio module 280 may process sound information input or output through a speaker 282, a receiver 284, an earphone 286, or the microphone 288. The camera module 291, as a device for capturing still images and videos, may include one or more image sensors (e.g., a front sensor or a rear sensor), a lens, an image signal processor (ISP), or a flash (e.g., an LED or a xenon lamp). The power management module 295, for example, may manage the power of the electronic device 201. According to an embodiment of the present disclosure, the power management module 295 may include a power management IC (PMIC), a charger IC, or a battery gauge, for example. The PMIC may have a wired and/or wireless charging method. The wireless charging method may include, for example, a magnetic resonance method, a magnetic induction method, or an electromagnetic method, and may further include an additional circuit for wireless charging, for example, a coil loop, a resonant circuit, or a rectifier circuit. The battery gauge may measure the remaining charge capacity of the battery 296, or a voltage, current, or temperature of the battery 296 during charging. The battery 296 may include, for example, a rechargeable battery and/or a solar battery.

The indicator 297 may display a specific state of the electronic device 201 or part thereof (e.g., the processor 210), for example, a booting state, a message state, or a charging state. The motor 298 may convert electrical signals into a mechanical vibration and generate a vibration or haptic effect. The electronic device 201 may include a mobile TV supporting device (e.g., a GPU) for processing media data according to standards such as digital multimedia broadcasting (DMB), digital video broadcasting (DVB), or MediaFlo™. Each of the above-described components of the electronic device may be configured with at least one component and the name of a corresponding component may vary according to the kind of electronic device. According to an embodiment of the present disclosure, the electronic device 201 may be configured to include at least one of the above-described components or an additional component, or to not include some of the above-described components. Additionally, some of components in an electronic device are configured as one entity, so that functions of previous corresponding components are performed identically.

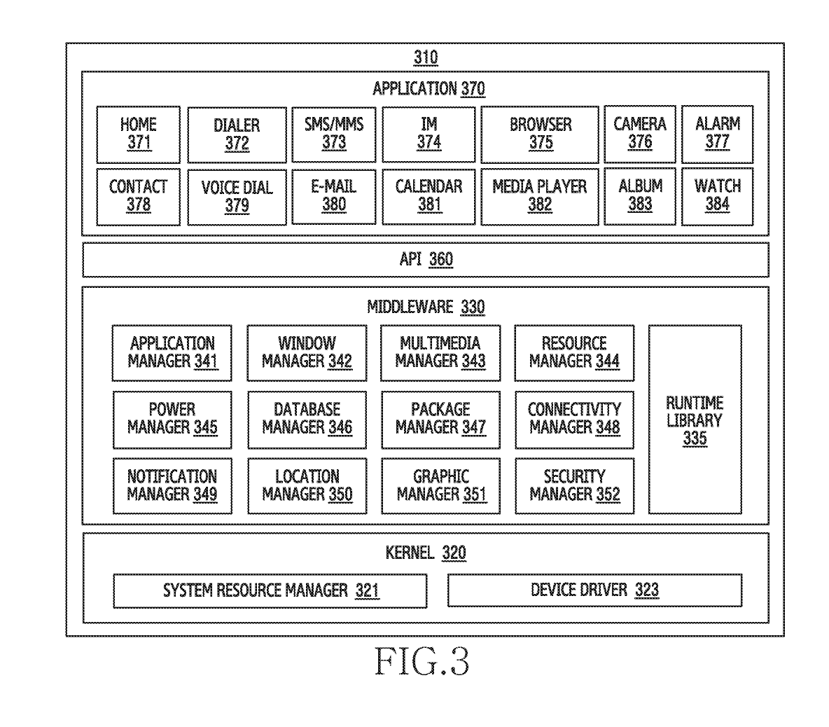

FIG. 3 is a block diagram of a program module, according to an embodiment of the present disclosure. A program module 310 (e.g., the program 140) may include an OS for controlling a resource relating to the electronic device 101 and/or the applications 147 running on the OS. The OS may include, for example, Android™, iOS™, Windows™, Symbian™, Tizen™, or Bada™. Referring to FIG. 3, the program module 310 includes a kernel 320 (e.g., the kernel 141), a middleware 330 (e.g., the middleware 143), an API 360 (e.g., the API 145), and/or an application 370 (e.g., the applications 147). At least part of the program module 310 may be preloaded on an electronic device or may be downloaded from an external electronic device (e.g., the first external electronic device 102, the second external electronic device 104, or the server 106).

The kernel 320 includes, for example, at least one of a system resource manager 321 and/or a device driver 323. The system resource manager 321 may control, allocate, or retrieve a system resource. According to an embodiment of the present disclosure, the system resource manager 321 may include a process management unit, a memory management unit, or a file system management unit. The device driver 323 may include, for example, a display driver, a camera driver, a Bluetooth™ driver, a shared memory driver, a USB driver, a keypad driver, a Wi-Fi driver, an audio driver, or an inter-process communication (IPC) driver. The middleware 330, for example, may provide a function commonly required by the application 370, or may provide various functions to the application 370 through the API 360 in order to allow the application 370 to efficiently use a limited system resource inside the electronic device. The middleware 330 includes at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module used by a compiler to add a new function through a programming language while the application 370 is running. The runtime library 335 may manage input/output, manage memory, or arithmetic function processing. The application manager 341, for example, may manage the life cycle of the applications 370. The window manager 342 may manage a GUI resource used in a screen. The multimedia manager 343 may recognize a format for playing various media files and encode or decode a media file by using the codec in a corresponding format. The resource manager 344 may manage a source code of the application 3740 or a memory space. The power manager 345 may manage the capacity, temperature, and/or power of the battery, and determine or provide power information for an operation of the electronic device using corresponding information among the capacity, temperature, and/or power of the battery. The power manager 345 may operate together with a basic input/output system (BIOS). The database manager 346 may create, search, or modify a database used in the application 370. The package manager 347 may manage installation or updating of an application distributed in a package file format.

The connectivity manager 348 may manage, for example, a wireless connection. The notification manager 349 may provide an event, such as incoming messages, appointments, and proximity alerts, to the user. The location manager 350 may manage location information of an electronic device. The graphic manager 351 may manage a graphic effect to be provided to the user or a user interface relating thereto. The security manager 352 may provide, for example, system security or user authentication. The middleware 330 may include a telephony manager for managing a voice or video call function of the electronic device, or a middleware module for combining various functions of the above-described components. The middleware 330 may provide a module specialized for each type of OS. The middleware 330 may dynamically delete part of the existing components or add new components. The API 360, as a set of API programming functions, may be provided as another configuration according to the OS. For example, Android or iOS may provide one API set for each platform, and Tizen may provide two or more API sets for each platform.

The application 370 includes at least one of a home 371, a dialer 372, an SMS/multimedia messaging system (MMS) 373, an instant message (IM) 374, a browser 375, a camera 376, an alarm 377, a contact 378, a voice dial 379, an e-mail 380, a calendar 381, a media player 382, an album 383, a clock 384. Additionally, the application 370 may include health care (e.g., measure an exercise amount or blood sugar level), or environmental information (e.g., air pressure, humidity, or temperature information) application. The application 370 may include an information exchange application for supporting information exchange between the electronic device and an external electronic device. The information exchange application may include, for example, a notification relay application for relaying specific information to the external device or a device management application for managing the external electronic device. The notification relay application may relay notification information from another application of the electronic device to an external electronic device, or receive and forward notification information from an external electronic device to the user. The device management application, for example, may install, delete, or update a function (e.g., turn-on/turn off of the external electronic device itself (or some components) or display brightness (or resolution) adjustment) of an external electronic device communicating with the electronic device, or an application operating in the external electronic device. The application 370 may include a specific application (e.g., a health care application of a mobile medical device) according to a property of the external electronic device. The application 370 may include an application received from an external electronic device. At least part of the program module 310 may be implemented (e.g., executed) with software, firmware, hardware (e.g., the processor 210), or a combination of at least two of them, and include a module, a program, a routine, a set of instructions, or a process for executing one or more functions.

The term “module”, as used herein, may refer, for example, to a unit including hardware, software, and firmware, or any suitable combination thereof. The term “module” can be interchangeably used with terms such as “unit”, “logic”, “logical block”, “component”, “circuit”, and the like. A module can be a minimum unit of an integral component or can be a part thereof. A module can be a minimum unit for performing one or more functions or may be a part thereof. A module can be mechanically or electrically implemented. For example, a module, according to an embodiment of the present disclosure, can include, for example, and without limitation, at least one of a dedicated processor, a CPU, an Application-Specific Integrated Circuit (ASIC) chip, a Field-Programmable Gate Arrays (FPGAs), and a programmable-logic device, which are known or will be developed and which perform certain operations. At least some parts of a device (e.g., modules or functions thereof) or a method (e.g., operations), based on embodiments of the present disclosure, can be implemented with an instruction stored in a non-transitory computer-readable storage medium (e.g., the memory 130) as a program module. When the instruction is executed by a processor (e.g., the processor 120), the processor can perform a function corresponding to the instruction. The non-transitory computer readable recording medium can include, for example, a hard disk, a floppy disc, a magnetic medium (e.g., a magnetic tape), an optical storage medium (e.g., a Compact Disc-ROM (CD-ROM) or a DVD, a magnetic-optic medium (e.g., a floptical disc)), and an internal memory. The instruction can include code created by a compiler or code executable by an interpreter. The module or program module can further include at least one or more components among the aforementioned components, or can omit some of them, or can further include additional other components. Operations performed by a module, program module, or other components of the various embodiments of the present disclosure can be executed in a sequential, parallel, repetitive, or heuristic manner. In addition, some of the operations can be executed in a different order or may be omitted, or other operations may be added.

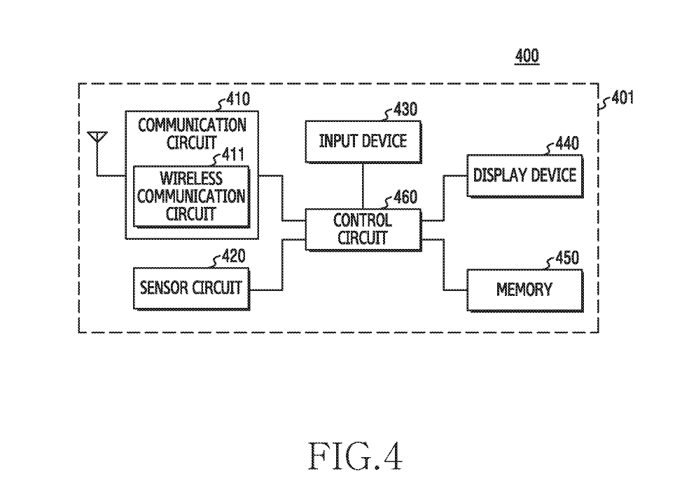

FIG. 4 is a block diagram illustrating a main construction of an electronic device detecting an accessory device of an embodiment of the disclosure.

Referring to FIG. 4, the electronic device 400 of an embodiment of the disclosure may include a communication circuit 410 (e.g., the communication module 220), a sensor circuit 420 (e.g., the sensor module 240), an input device 430 (e.g., the input device 250), a display device 440 (e.g., the display 260), a memory 450 (e.g., the memory 230), and a control circuit 460 (e.g., the processor 210).

The communication circuit 410 may perform communication in the electronic device 400. At this time, the communication circuit 410 may communicate with an external device (not shown) such as a server, other electronic device, etc., in various schemes. The communication circuit 410 may perform at least one of wireless communication or wired communication. For this, the communication circuit 410 may connect to at least one of a mobile communication network or a data communication network.

The communication circuit 410 may perform wireless communication with an accessory device. For this, the communication circuit 410 may include a wireless communication circuit 411. The wireless communication circuit 411 may perform short-range communication with the accessory device. Herein, the communication scheme may include short-range wireless communication such as near field communication (NFC), Bluetooth, RFID, etc. The communication circuit 410 may receive information (e.g., an identification number of the accessory device, authentication information, accessory device information, etc.) from the accessory device, and provide the received information to the control circuit 460.

The sensor circuit 420 may detect that the accessory device is mounted or non-mounted on the electronic device 400. The sensor circuit 420 may detect whether the human body approaches the electronic device 400. For this, the sensor circuit 420 may include at least one or more of a touch sensor, a grip sensor, a proximity sensor, an electrostatic/electric field detection sensor, etc. In response to it being detected that capacitance is changed by a dielectric substance provided in the accessory device or the capacitance is changed by the human body, the sensor circuit 420 may transmit sensing information corresponding to this, to the control circuit 460.

The sensor circuit 420 may detect whether an accessory device of a cover form is positioned at an upper part of the display device 440 of the electronic device 400. The sensor circuit 420 may include a hall sensor (e.g., a hall IC) capable of detecting the approach of a magnetic substance included in the accessory device. In response to the magnetic properties being detected, the sensor circuit 420 may transmit sensing information corresponding to this, to the control circuit 460.

The input device 430 may provide input data in the electronic device 400. At this time, the input device 430 may provide the input data correspondingly to a user input of the electronic device 400. The input device 430 may include at least one input means. This input device 430 may include a key pad, a dome switch, a physical button, a touch panel, and a jog & shuttle.

The display device 440 may display screen data that includes a wait screen, an execution screen of an application that is being executed, and an execution screen of call reception (i.e., a phone call, a message, etc.), by the control of the control circuit 460. The display device 440 may set a display region by the control of the control circuit 460. The display device 440 may display, in the display region, screen data corresponding to the accessory device by the control of the control circuit 460. The display region may be a partial region of the display device 440 corresponding to a display window formed in the accessory device or a partial region of the display device 440 exposed by the accessory device. This display device 440 may include a liquid crystal display (LCD), a light emitting diode (LED) display, an organic LED (OLED) display, a micro electro mechanical systems (MEMS) display, and an electronic paper display. The display device 440 may include a plurality of light emitting elements. The display device 440 may be combined with the input device 430 and be implemented as a touch screen.

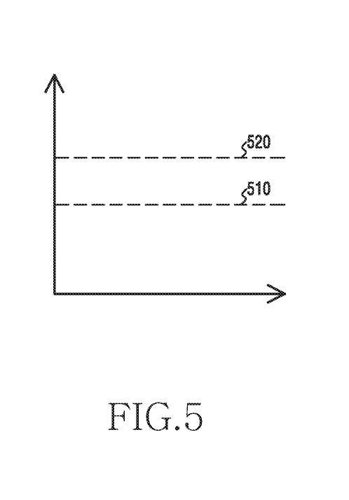

The memory 450 may store operation programs of the electronic device 400. The memory 450 may store a first threshold value that is a criterion of identifying that the accessory device approaches or comes in contact with the electronic device 400. The memory 450 may store a second threshold value that is a criterion of identifying that a part of the human body approaches or comes in contact with the electronic device 400. The first threshold value and the second threshold value are explained in more detail with reference to FIG. 5.

FIG. 5 is a diagram for explaining a first threshold value and a second threshold value of an embodiment of the disclosure. According to an embodiment with reference to FIG. 5, a first threshold value 510 may be set smaller than a second threshold value 520. The first threshold value 510 may be a minimal value of capacitance capable of being detected by a dielectric substance provided in the accessory device. The second threshold value 520 may be a minimal value of capacitance capable of being detected by the human body. The first threshold value 510 and the second threshold value 520 may be set by a difference of permittivities of the dielectric substance and the human body.

According to an embodiment, the memory 450 may include execution information mapped to identification information of the accessory device for the sake of the authentication of the accessory device. The execution information may be stored using a Table such as Table 1 below. For example, the execution information may include properties of a display region dependent on the type of the accessory device. The properties of the display region may include a size, position, form, and display scheme of the display region.

TABLE 1

| | Number | | |
|---|---|---|---|
| | of allocated | | Composition |
| Item | bits | Details | example |
| Product name | 8 bits (256 types) | Project model | 00(hex) |
| Honest goods | 8 bits (256 types) | Honest goods/SMAPP | 00(hex) |
| or not | | | |
| Color | 8 bits (256 types) | Black/white, etc. | 00(hex) |
| Type | 8 bits (256 types) | Flip cover/S-view | 00(hex) |
| | | cover | |
| ID format | 8 bits (256 types) | ID format ver | 00(hex) |
| Manufacturing | 16 bits (65K) | Manufacturing | 0000(hex) |
| company | | company name | |
| information | | | |
| Manufacturing | 8 bits (256 types) | URI address | 00(hex) |
| company | | | |
| web page | | | |
| Physical key | 8 bits | Keyboard type | 00(hex) |
| type | | | |

According to an embodiment, the control circuit 460 may identify capacitance detected in the electronic device 400, through sensing information provided from the sensor circuit 420. In response to the capacitance being a value between the first threshold value and the second threshold value, the control circuit 460 may perform the authentication of the accessory device. In response to a success of the authentication of the accessory device, the control circuit 460 may control screen data.

In response to the capacitance being between the first threshold value and the second threshold value, the control circuit 460 may identify that the accessory device is mounted on the electronic device 400. The control circuit 460 may activate the wireless communication circuit 411, and receive identification information of the accessory device from the accessory device through the wireless communication circuit 411. The control circuit 460 may identify whether data mapped with the received identification information exists in the memory 450. The control circuit 460 may identify whether the accessory device is honest goods, based on the data related to the identification information. In response to the success of the authentication of the accessory device, the control circuit 460 may identify the execution information mapped to the identification information. The control circuit 460 may control screen data of the display device 440, based on the properties of the display region dependent on the type of the accessory device among the identified execution information.

For example, in response to the identified accessory device having a form of covering the whole of the display device 440, the control circuit 460 may identify a size, position, and form of a display region formed in the accessory device. The control circuit 460 may change and display screen data on the whole or part of the display device 440 corresponding to the display region. For another example, in response to the identified accessory device having a form of covering a part of the display device 440, the control circuit 460 may identify a display scheme of screen data by the accessory device. The control circuit 460 may identify (provide) a partial region of the display device 440 exposed by the accessory device, as the display region. The control circuit 460 may reduce screen data or change and display at least a part of the screen data wherein the screen data corresponds to the identified display region.

According to an embodiment, in response to the capacitance being greater than the second threshold value, the control circuit 460 may identify that the human body approaches or comes in contact with the electronic device 400. For example, a case where the capacitance is greater than the second threshold value may occur in response to a user gripping the electronic device 400 in a state where the accessory device is non-mounted, and may occur in response to the user gripping the electronic device 400 in a state where the accessory device has been mounted on the electronic device 400.

According to an embodiment, in response to the capacitance being greater than the second threshold value, the control circuit 460 may activate the wireless communication circuit 411, and receive identification information of the accessory device from the accessory device through the wireless communication circuit 411. In response to the identification number (e.g., identification number) not being received from the accessory device through the wireless communication circuit 411, it may be identified that it is a state where the electronic device 400 is gripped with a hand with the accessory device not being mounted. Also, in response to the identification information having been received from the accessory device through the wireless communication circuit 411, but the identification information not existing in the memory 450, the control circuit 460 may identify that the accessory device is not honest goods. In response to it being a state where the electronic device 400 is gripped, or the accessory device not being the honest goods, the control circuit 460 may not perform the control of screen data displayed on the display device 440. According to an embodiment, in response to it being detected that capacitance is changed equal to or less than the first threshold value during the control of the screen data, the control circuit 460 may identify that the accessory device is non-mounted on the electronic device 400. The control circuit 460 may restore the screen data which is being controlled, to screen data which is displayed on the display device 440 before the accessory device is detected, and display the screen data.

On the other hand, the above description is made by way of an example in which the electronic device 400 of an embodiment of the disclosure stores the execution information mapped with the identification information in the memory 450, but is not necessarily limited to this. The electronic device 400 may transmit the identification information received from the accessory device, to an external server (not shown), etc., and receive the execution information corresponding to the identification information from the server. The electronic device 400 may perform the authentication of the accessory device by means of the received execution information, and may identify the properties information of the display region, based on the type of the accessory device and the type. The electronic device 400 may control the screen data displayed on the display device 440, based on the identified properties information.

Also, the electronic device 400 may store the identification information, and execution information excepting the properties of the display region dependent on the type of the accessory device among the execution information. In response to the completion of the authentication of the accessory device, the electronic device 400 may request the properties of the display region to the accessory information. The electronic device 400 may receive the properties of the display region from the accessory information and, based on this, control the screen data displayed on the display device 440.

According to an embodiment, the electronic device 400 detecting an accessory device may include an external housing 401 including a first surface facing a first direction, a second surface facing a second direction opposite to the first direction, and a side surface surrounding at least a part of the space between the first surface and the second surface, a user interface exposed through at least a part of the first surface, the second surface, and the side surface of the housing 401, a communication circuit 410 disposed inside the housing 401, a first sensor (for instance, at least one of a touch sensor, a grip sensor, a proximity sensor or an electrostatic/electric field detection sensor included in the sensor circuit 420) disposed inside the housing 401, a conductive member electrically connected to the first sensor, and disposed adjacent to at least a part of the second surface and/or the side surface of the housing 401, a processor (e.g., the control circuit 460) electrically connected to the communication circuit 410, the user interface, and the first sensor, and a memory 450 electrically connected to the processor 460, wherein the memory 450 may store instructions which, when executed, cause the processor 460 to detect whether an accessory device configured to be detachably mounted on the second surface of the housing 401 comes into contact with or approaches the conductive member, by using the first sensor, so as to generate a first signal, compare the first signal with at least one threshold value, and perform at least one action through at least one of the communication circuit and the user interface, on the basis of the result of the comparison.

According to an embodiment, the instructions may cause the processor 460 to detect a change of capacitance formed between the accessory device and the conductive member, by using the first sensor, so as to provide the first signal.

According to an embodiment, the instructions may cause the processor 460 to activate at least one of the user interface and the communication circuit 410 in response to the first signal including a value higher than the at least one threshold value.

According to an embodiment, the instructions may cause the processor 460 to form connection with the accessory device by using the communication circuit 410 in response to the first signal including a value higher than the at least one threshold value.

According to an embodiment, the instructions may cause the processor 460 to receive at least one data from the accessory device, by using the communication circuit 410, and authenticate the accessory device on the basis of the received at least one data.

According to an embodiment, the instructions may cause the processor 460 to output a second signal through the user interface in response to the first signal including a value higher than the at least one threshold value.

According to an embodiment, the instructions may cause the processor 460 to output a second signal through the user interface, and change the outputted second signal in response to the first signal including a value higher than the at least one threshold value.

According to an embodiment, the at least one threshold value may include a first threshold value and a second threshold value, and it may cause to execute a first action in response to the first signal including a value higher than the first threshold value and the second threshold value, and execute a second action in response to the first signal including only a value between the first threshold value and the second threshold value.

According to an embodiment, the first action may be an action of decreasing a strength of a signal transmitted to the external through the communication circuit 410, and the second action may be an action of forming a connection with the accessory device.

According to an embodiment, the electronic device 400 may further include a second sensor (for instance, a hall sensor included in the sensor circuit 420) disposed adjacent to a first surface rather than a second surface, inside the housing 401.

According to an embodiment, the instructions may cause the processor 460 to detect a magnetic flux provided from a magnetic substance included in the accessory device, by using the second sensor, so as to execute at least one another action.

According to an embodiment, the accessory device may include a portion which is configured to openably and closably cover the first surface of the housing 401.

According to an embodiment, the communication circuit 410 may include a near field communication (NFC) circuit.

According to an embodiment, the user interface may include at least one of a display, a speaker, a vibration element, or a light emitting diode.

According to an embodiment, the electronic device 400 detecting an accessory device may include the sensor circuit 420 detecting a change of capacitance and the control circuit 460 performing authentication of the accessory device in response to the changed capacitance being a value exceeding the first threshold value, and controlling screen data in response to a success of the authentication of the accessory device.

According to an embodiment, the control circuit 460 may perform the authentication of the accessory device in response to the capacitance being a value between the first threshold value and the second threshold value exceeding the first threshold value.

According to an embodiment, the control circuit 460 may identify the first threshold value that is a minimal value of capacitance detected by a dielectric substance provided in the accessory device. The control circuit 460 may identify the second threshold value that is a minimal value of capacitance detected by the human body.

According to an embodiment, the control circuit 460 may identify the properties of a display region including a size, position, form and display scheme of the display region by the type of the accessory device. The control circuit 460 may display screen data, based on the size, position and form of the display region, wherein the screen data corresponds to the display region. The control circuit 460 may change and display the screen data, based on the display scheme of the display region.

According to an embodiment, the control circuit 460 may perform the authentication of the accessory device in response to the changed capacitance being equal to or greater than the second threshold value exceeding the first threshold value.

According to an embodiment, it may further include the wireless communication circuit 411 for wireless communication with the accessory device, and the control circuit 460 may receive identification information from the accessory device through the wireless communication circuit 411, and identify identification information corresponding to the received identification information.

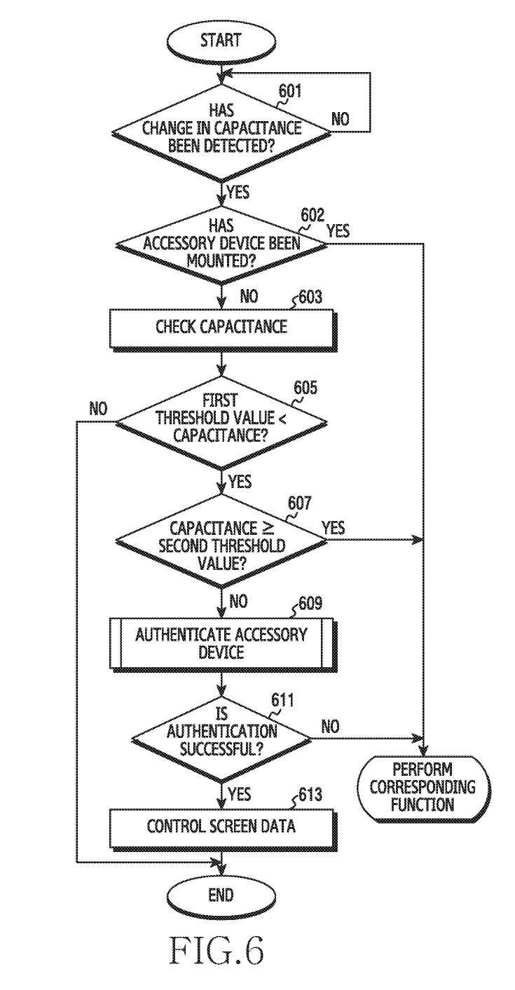

FIG. 6 is a flowchart for explaining a method of detecting an accessory device of an embodiment of the disclosure.

Referring to FIG. 6, in response to a change of capacitance being detected in the sensor circuit 420 in operation 601, the control circuit 460 may perform operation 602. In operation 602, the control circuit 460 may identify whether it is a state where an accessory device has been mounted. For example, in response to it being identified that a change of capacitance is maintained for a given time, the control circuit 460 may perform operation 602. For another example, in response to periodically identifying capacitance and detecting a change, the control circuit 460 may perform operation 602. In response to it being a state where the accessory device has been mounted as the identifying result of operation 602, the control circuit 460 may perform a corresponding function. At this time, a case where the change of capacitance occurs in a state where the accessory device has been mounted is a case where an operation of user's gripping of the electronic device 400, etc. occurs. The control circuit 460 may perform a corresponding function corresponding to the user's gripping of the electronic device 400, etc. In addition, the control circuit 460 may identify the change of capacitance in the state where the accessory device has been mounted, after a given time or every given cycle. In response to the change of capacitance not being detected in operation 601, the control circuit 460 may wait detecting of the change of capacitance.

In response to it not being the state where the accessory device has been mounted as the identifying result of operation 602, the control circuit 460 may proceed to operation 603 and identify the capacitance. At this time, the sensor circuit 420 may include at least one or more of a touch sensor, a grip sensor, a proximity sensor, an electrostatic/electric field detection sensor or the like which is capable of detecting the change of capacitance provided from the electronic device 400.

In operation 605, the control circuit 460 may compare the identified capacitance and a preset first threshold value. In response to the identified capacitance being less than the first threshold value as the comparison result of operation 605, the control circuit 460 may terminate the process. In response to the identified capacitance being equal to or greater than the first threshold value as the comparison result of operation 605, the control circuit 460 may perform operation 607.

In operation 607, the control circuit 460 may identify whether the identified capacitance is equal to or is greater than a preset second threshold value.

In response to the identified capacitance being equal to or greater than the second threshold value as the comparison result of operation 607, the control circuit 460 may perform a corresponding function. At this time, a case where the capacitance is equal to or is greater than the second threshold value may be a case where an operation of user's gripping of the electronic device 400, etc. occurs. The control circuit 460 may perform a corresponding function corresponding to the user's gripping of the electronic device 400, etc.

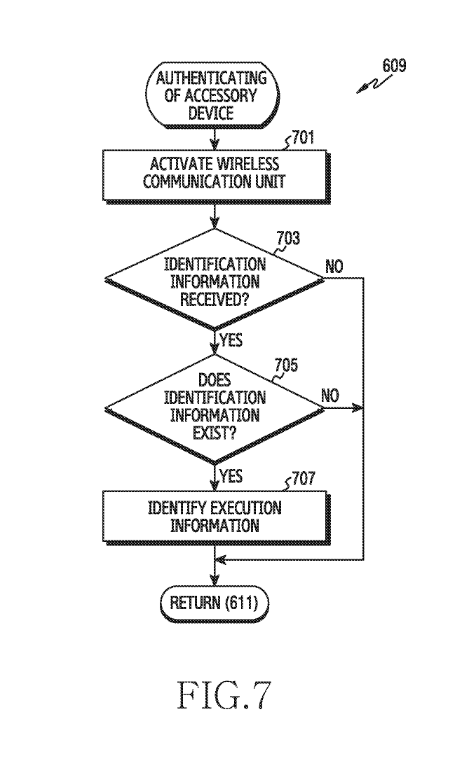

In response to the identified capacitance being less than the second threshold value as the comparison result of operation 607, the control circuit 460 may perform operation 609. In operation 609, the control circuit 460 may perform the authentication of the accessory device. In response to the identified capacitance existing between the first threshold value and the second threshold value, the control circuit 460 may identify that the accessory device has been mounted on the electronic device 400. The authentication of the accessory device is described in more detail with reference to FIG. 7.

FIG. 7 is a flowchart for explaining a method for performing the authentication of the accessory device of an embodiment of the disclosure.

Referring to FIG. 7, in operation 701, the control circuit 460 may activate the wireless communication circuit 411. The control circuit 460 may activate the wireless communication circuit for performing communication with the accessory device. For example, the control circuit 460 may apply power to the wireless communication circuit 411, to activate the wireless communication circuit 411. The wireless communication circuit 411 may include at least one of near field communication (NFC), wireless fidelity (WiFi), Bluetooth, Bluetooth low energy (BLE), Zigbee, magnetic secure transmission, radio frequency (RF), etc.

In operation 703, the control circuit 460 may identify whether identification information of the accessory device is received from the accessory device through the wireless communication circuit 411. In response to the identification information of the accessory device not being received as the identifying result of operation 703, the control circuit 460 may return to operation 611 of FIG. 6. For example, the control circuit 460 may stop applying of power to the wireless communication circuit 411, to inactivate the wireless communication circuit 411. In response to the accessory device not being honest goods, the accessory device may not be allocated an identification number and therefore, the accessory device may be impossible to transmit the identification number to the control circuit 460. In operation 611, the authentication of the accessory device does not succeed, so the control circuit 460 may perform a corresponding function. For example, the accessory device is not honest goods, so the control circuit 460 may perform a corresponding function of maintaining screen data, etc. The screen data may be a wait screen of the electronic device 400 or an execution screen of an application being in execution.

In response to the identification information of the accessory device being received as the identifying result of operation 703, the control circuit 460 may perform operation 705. In operation 705, the control circuit 460 may identify whether the identification information exists in the memory 450. In response to the identification information existing in the memory 450 as the comparison result of operation 705, the control circuit 460 may perform operation 707. In response to the identification information not existing in the memory 450 as the identifying result of operation 705, the control unit 460 may identify that the accessory device is not the honest goods, and return to operation 611 of FIG. 6. Operation 611 has been explained in the above and therefore, its detailed description is omitted.

In operation 707, the control circuit 460 may identify execution information of the accessory device which has been mapped to the identification information and stored in the memory 450. For example, the control circuit 460 may identify a product name of the accessory device, honest goods or not, a color, a type, an ID format, manufacturing company information, a manufacturing company web page, or a physical key type, etc., as in Table 1, based on the identification information. Also, the control circuit 460 may identify at least one of a size, position, form and display scheme of a display region formed in the accessory device from properties information of the display region dependent on the type of the accessory device. The control circuit 460 having identified the execution information may authenticate that the accessory device is the honest goods, and return to operation 611 of FIG. 6.

In operation 611, the control circuit 460 has identified (authenticated) that the identification information has been stored in the memory 450 and thus, may perform operation 613. In operation 613, the control circuit 460 may control screen data. For example, in response to the accessory device being a physical keypad mounted on a part of the display device 440, the control circuit 460 may identify a display scheme of the physical keypad. The control circuit 460 may display screen data in a region (for instance, display region) excepting a region where the physical keypad is mounted on the display device 440. At this time, the control circuit 460 may reduce screen data displayed on the display device 440 or change at least a part of the screen data, and display the screen data, wherein the screen data corresponds to the display region. Also, the control circuit 460 may identify that the accessory device is a device which has a cover form of covering the whole of the display device 440 and has a display window exposing a partial region among the whole of the display device 440. The control circuit 460 may identify a size, position and form of the display window. In response to it being identified that the accessory device of the cover form covers the display device 440, the control circuit 460 may change and display the screen data in the display region corresponding to the display window according to the identified display properties. The display region may be a part or whole of the display device 440 corresponding to the display window. At this time, the control circuit 460 may identify that the accessory device covers the display device 440 through detecting of a magnetic substance provided in the accessory device. For example, the control circuit 460 may detect a magnetic substance through a magnetic sensor (e.g., hall sensor) capable of detecting a magnetic force.

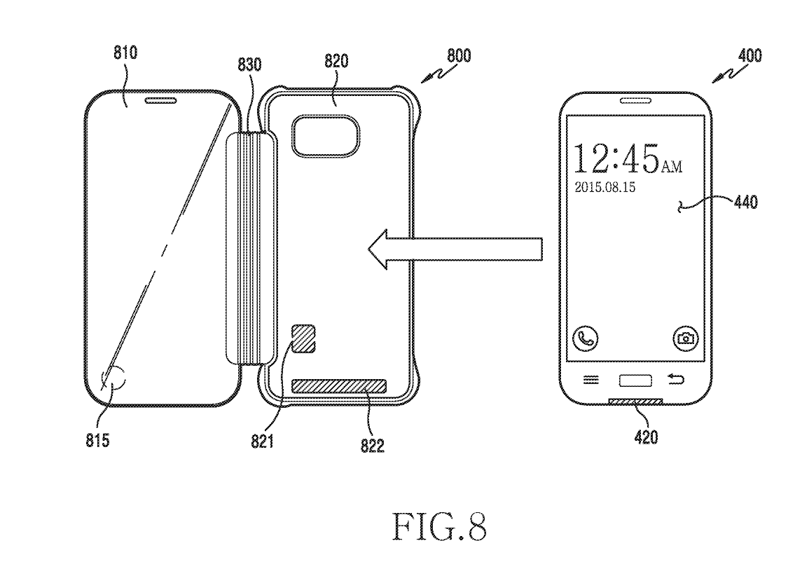

FIG. 8 is a screen example diagram for explaining the forms of an accessory device and an electronic device of an embodiment of the disclosure.

Referring to FIG. 8, the accessory device 800 may be mounted on the electronic device 400. The sensor circuit 420 may be provided at a lower end of the electronic device 400. The accessory device 800 may have a front part 810 covering the display device 440 of the electronic device 400 and a rear part 820 covering a rear surface of the electronic device 400. The accessory device 800 may have a hinge part 830 wherein the hinge part 830 connects the front part 810 and the rear part 820, and wherein the front part 810 and the rear part 820 are folded to face each other. A magnetic substance 815 may be provided at one side of the front part 810 of the accessory device 800. A communication module 821 for wireless communication with the wireless communication circuit 411 of the electronic device 400 may be provided at the rear part 820 of the accessory device 800. The communication module 821 may be a module (e.g., NFC tag) for short-range wireless communication such as NFC communication, etc. A dielectric substance 822 may be provided at the rear part 820 of the accessory device 800. The dielectric substance 822 may be provided in a position that may approach or come in contact with to the sensor circuit 420 of the electronic device 400 in response to the accessory device 800 being mounted on the electronic device 400. In response to the accessory device 800 being mounted on the electronic device 400, the accessory device 800 may transmit identification information of the accessory device 800 to the electronic device 400 through the communication module 821.

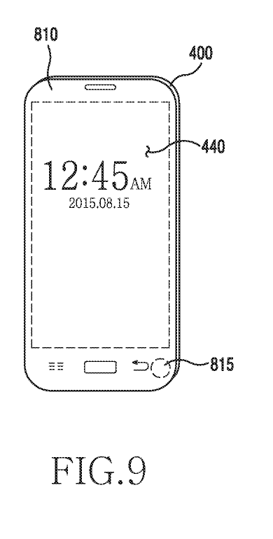

FIG. 9 is a screen example diagram for explaining a state of an electronic device on which an accessory device of an embodiment of the disclosure is mounted.

Referring to FIG. 8 and FIG. 9, in response to it being identified that the accessory device 800 is mounted on the electronic device 400, and the front part 810 is positioned at an upper part of the display device 440, the electronic device 400 may change screen data displayed on the display device 440, and display the changed screen data. In response to it being identified that the magnetic substance 815 provided in the front part 810 comes in contact with the display device 440, the electronic device 400 may identify that the front part 810 covers the display device 440.

In a state where the screen data has been displayed on the display device 440 as in FIG. 8, the electronic device 400 may detect the mounting of the accessory device 800 of which the whole of the front part 810 is a display window. The electronic device 400 may identify whether the front part 810 of the accessory device 800 is positioned at an upper part of the display device 440 of the electronic device 400 in a state the accessory device 800 has been mounted. In response to the magnetic substance 815 provided in the front part 810 being identified, the electronic device 400 may identify that the front part 810 covers the upper part of the display device 440. In that the accessory device 800 is an accessory device of which the whole of the front part 810 is the display window, the electronic device 400 may change the screen data of FIG. 8 displayed in the display region of the display device 440 corresponding to the display window, into screen data of FIG. 9, and display the screen data.

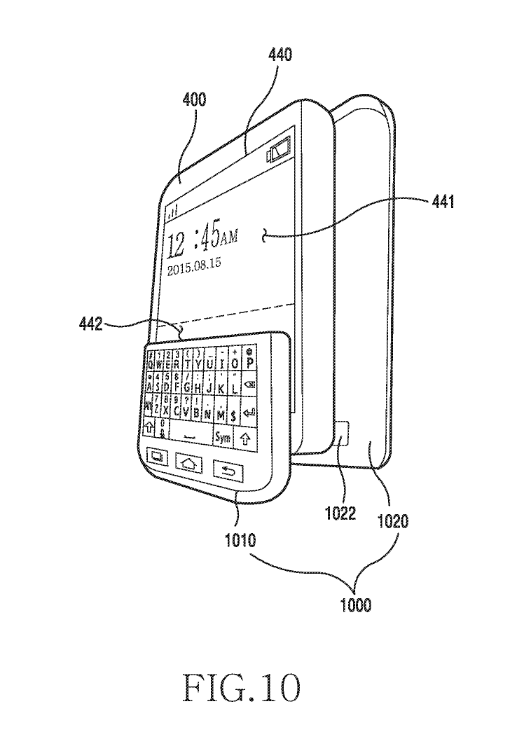

FIG. 10 is a screen example diagram for explaining the forms of an accessory device and an electronic device of an embodiment of the disclosure.

Referring to FIG. 10, the accessory device 1000 may have a rear part 1020 combined to a rear surface of the electronic device 400 and a front part 1010 combined to a part of the display device 440 of the electronic device 400. Though not illustrated, a communication module for wireless communication with the wireless communication circuit 411 of the electronic device 400 may be provided at the rear part 1020 of the accessory device 1000. A dielectric substance 1022 may be provided in the rear part 1020 of the accessory device 1000. The dielectric substance 1022 may be provided in a position that may approach or come in contact with to the sensor circuit 420 of the electronic device 400 in response to the accessory device 1000 being mounted on the electronic device 400. The accessory device 1000 may transmit identification information of the accessory device 1000 to the electronic device 400 through the communication module. The front part 1010 of the accessory device 1000 may include a physical keypad.

In response to the front part 1010 of the accessory device 1000 being combined to the display device 440 of the electronic device 400, one may identify a first region 441 of the display device 440 to which the front part 1010 is not combined, and a second region 442 of the display device 440 corresponding to the front part 1010. The electronic device 400 may identify a size of the front part 1010 from execution information corresponding to an identification number of the accessory device 1000, and may set, as a display region, the first region 441 exposed by the front part 1010 in the display device 440, based on the identified size of the front part 1010. In response to the mounting of the accessory device 1000 being identified, the electronic device 400 may reduce screen data displayed in the whole region of the display device 440 or change at least a part of the screen data, and display the screen data, wherein the screen data corresponds to the display region 441.

In addition, an embodiment of the disclosure is explained by way of an example in which the accessory device 1000 is comprised of the front part 1010 and the rear part 1020, but is not necessarily limited to this. The accessory device 1000 may be comprised of only the front part 1010 without the rear part 1020. In this case, a communication module for wireless communication with the wireless communication circuit 411 of the electronic device 400 may be provided in the front part 1010. The front part 1010 may include a dielectric substance in a position that may approach or come in contact with to the sensor circuit 420 of the electronic device 400 in response to being combined to the electronic device 400.

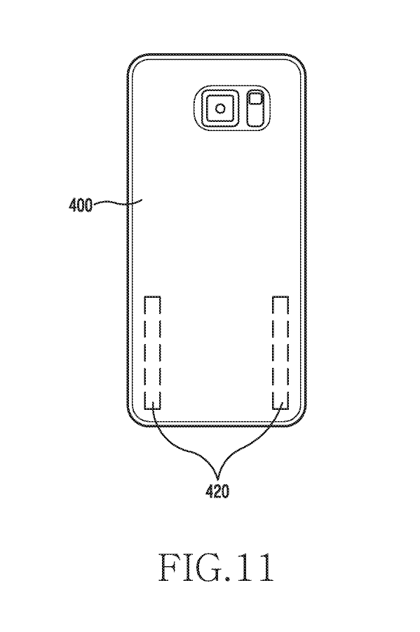

FIG. 11 is a screen example diagram for explaining a position of a sensor detecting capacitance, provided in an electronic device of an embodiment of the disclosure.

Referring to FIG. 11, the sensor circuit 420 provided in the electronic device 400 may be provided at a lower end of the electronic device 400. As in FIG. 11, at least one sensor circuit 420 may be provided at a rear surface of the electronic device 400. An embodiment of the disclosure is explained by way of an example in which two sensor circuits 420 are provided in parallel at the rear surface of the electronic device 400, but is not necessarily limited to this. The sensor circuit 420 may be provided at a side surface of the electronic device 400, or may be provided anywhere at a position of approaching or coming in contact with the human body at a time a user grips the electronic device 400.

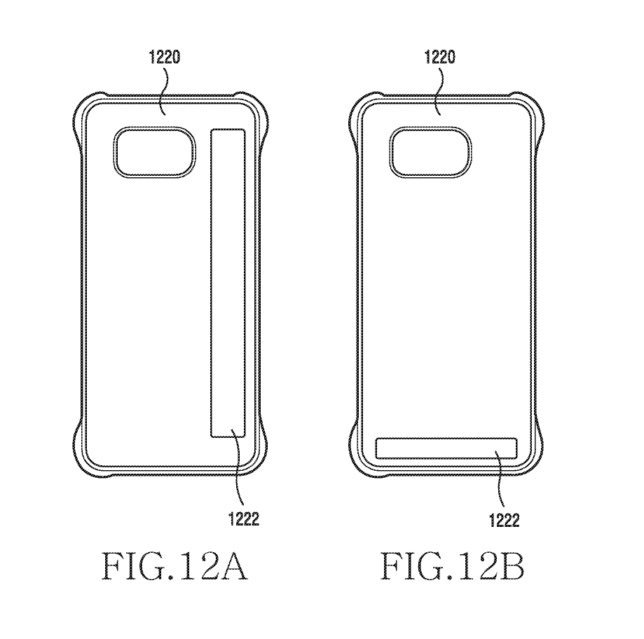

FIG. 12 is a screen example diagram for explaining a position of a dielectric substance provided in an accessory device of an embodiment of the disclosure.

Referring to FIG. 12, as in FIG. 12(a), the dielectric substance 1222 may be provided in a vertical direction at an edge of a rear part 1220 of the accessory device. Also, as in FIG. 12(b), the dielectric substance 1222 may be provided in a horizontal direction at a lower end of the rear part 1220 of the accessory device. At this time, the dielectric substance 1222 may be provided in a position which approaches or comes in contact with the sensor circuit 420 provided in the electronic device 400 in response to the accessory device being mounted on the electronic device 400. An embodiment of the disclosure is explained by way of an example in which one dielectric substance 1222 is provided in the rear part 1220 of the accessory device, but is not necessarily limited to this. The dielectric substance 1222 may be provided in at least one of the rear part 1220 or front part (not shown) of the accessory device. Also, a plurality of the dielectric substances 1222 may be provided.

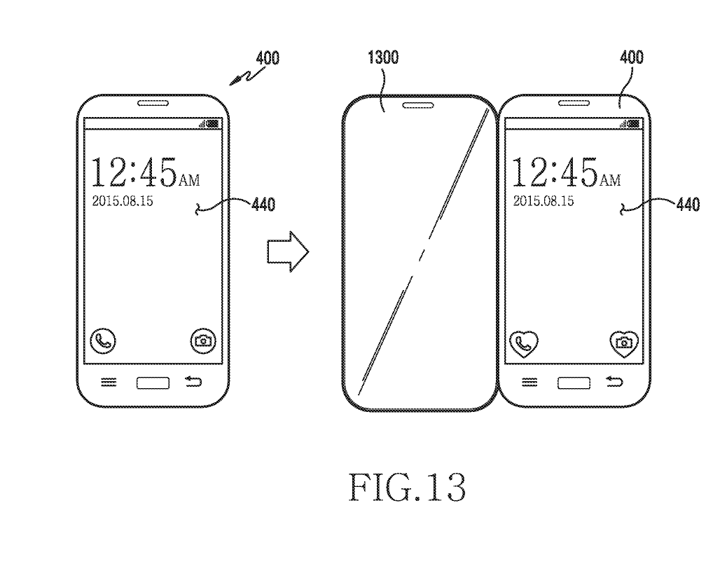

FIG. 13 is a screen example diagram for explaining a screen configuration of an electronic device at mounting of an accessory device of an embodiment of the disclosure.

Referring to FIG. 13, as in FIG. 13, an accessory device 1300 may be mounted in a state where a wait screen has been displayed on the display device 440 of the electronic device 400. The electronic device 400 may identify execution information of the mounted accessory device 1300. The electronic device 400 may change the wait screen displayed on the display device 440 correspondingly to the identified execution information of the accessory device 1300. For example, the electronic device 400 may change a font of a time and date indicator displayed on the wait screen before the accessory device 1300 is mounted, and display the same on the display device 440. The electronic device 400 may change the forms of phone and camera icons displayed on the wait screen before the accessory device 1300 is mounted, and display the same on the display device 440.

An embodiment of the disclosure illustrates changing the forms of the font and icon of the indicators displayed on the wait screen correspondingly to the execution information of the accessory device 1300, but is not necessarily limited to this. The electronic device 400 may change various settings such as a theme, a screen color, etc. of the electronic device 400 correspondingly to the execution information of the accessory device 1300.

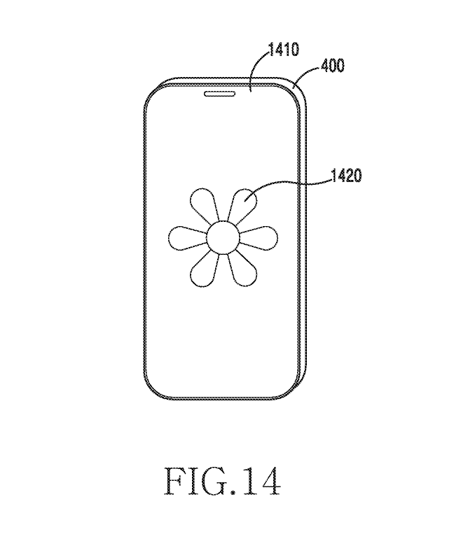

FIG. 14 is a screen example diagram for explaining a screen configuration of an accessory device at mounting of the accessory device of an embodiment of the disclosure.

Referring to FIG. 14, in response to the accessory device 1410 being mounted on the electronic device 400, the electronic device 400 may transmit screen data to the accessory device 1410. The accessory device 1410 may display the screen data 1420 received from the electronic device 400. For this, the accessory device 1410 may include a LED, a display device, etc. The electronic device 400 may transmit, to the accessory device 1410, screen data to be displayed on the accessory device 1410 at reception of a phone call, a message, etc., in a state where the accessory device 1410 has been mounted. The electronic device 400 may transmit the screen data to the accessory device 1410 by using the wireless communication circuit 411.

According to an embodiment, an operation method of the electronic device 400 detecting an accessory device may include detecting a change of capacitance, performing the authentication of the accessory device in response to the detected capacitance being a value exceeding a first threshold value, and controlling screen data in response to a success of the authentication of the accessory device.

According to an embodiment, performing the authentication of the accessory device may be performing the authentication of the accessory device in response to the capacitance being a value between the first threshold value and a second threshold value having a value higher than the first threshold value.

According to an embodiment, the first threshold value may be a minimal value of capacitance detected by a dielectric substance provided in the accessory device, and the second threshold value may be a minimal value of capacitance detected by the human body.

According to an embodiment, capacitance may be capacitance detected by a sensor including a grip sensor, a touch sensor, a proximity sensor and an electrostatic/electric field detecting sensor provided in the electronic device 400.

According to an embodiment, performing the authentication may further include identifying properties of a display region dependent on the type of the accessory device. The properties of the display region may include a size, position, form and display scheme of the display region.

According to an embodiment, controlling the screen data may include displaying the screen data, based on the size, position, and form of the display region, wherein the screen data corresponds to the display region. Controlling the screen data may further include changing the screen data, based on the display scheme of the display region, and displaying the changed screen data.

According to an embodiment, performing the authentication of the accessory device may further include performing the authentication of the accessory device in response to the detected capacitance being equal to or being greater than a second threshold value exceeding the first threshold value.

According to an embodiment, performing authentication may include activating the wireless communication circuit 411, and further include receiving identification information from an accessory device through the wireless communication circuit 411 and identifying execution information corresponding to the received identification information.

Meantime, embodiments of the disclosure disclosed in the present specification and drawings merely suggest specific examples so as to easily explain the technological content of the disclosure and help the understanding of the disclosure, and do not intend to limit the scope of the disclosure. That is, it is obvious to a person having ordinary skill in the art that other modified examples being based on the technological spirit of the disclosure may be embodied.

1. An electronic device comprising:
an external housing comprising a first surface facing a first direction, a second surface facing a second direction opposite to the first direction, and a side surface surrounding at least a part of the space between the first surface and the second surface;
a user interface exposed through at least a part of the first surface, the second surface, and the side surface of the housing;
a communication circuit disposed inside the housing;
a first sensor disposed inside the housing;
a conductive member electrically connected to the first sensor, and disposed adjacent to at least a part of the second surface and the side surface of the housing;
a processor operatively connected to the communication circuit, the user interface, and the first sensor; and
a memory operatively connected to the processor,
wherein the memory stores instructions which, when executed, cause the processor to:
detect whether an accessory device configured to be detachably mounted on the second surface of the housing comes into contact with or approaches the conductive member, by using the first sensor, so as to generate a first signal;
compare the first signal with at least one threshold value; and
perform at least one action through at least one of the communication circuit and the user interface, on the basis of the result of the comparison.

2. The device of claim 1, wherein the instructions cause the processor to detect a change of capacitance formed between the accessory device and the conductive member, by using the first sensor, so as to provide the first signal.

3. The device of claim 1, wherein the instructions cause the processor to activate at least one of the user interface and the communication circuit in response to the first signal comprising a value higher than the at least one threshold value.

4. The device of claim 1, wherein the instructions cause the processor to form connection with the accessory device by using the communication circuit in response to the first signal comprising a value higher than the at least one threshold value.

5. The device of claim 4, wherein the instructions cause the processor to:
receive at least one data from the accessory device, by using the communication circuit; and
authenticate the accessory device on the basis of the received at least one data.

6. The device of claim 1, wherein the instructions cause the processor to output a second signal through the user interface in response to the first signal comprising a value higher than the at least one threshold value.

7. The device of claim 1, wherein the instructions cause the processor to:
output a second signal through the user interface; and
change the outputted second signal in response to the first signal comprising a value higher than the at least one threshold value.

8. The device of claim 1, wherein the electronic device further comprises a second sensor disposed adjacent to the first surface rather than the second surface, inside the housing, and
the instructions cause the processor to
detect a magnetic flux provided from a magnetic substance comprised in the accessory device, by using the second sensor, so as to execute at least one another action.

9. The device of claim 1, wherein the communication circuit comprises a near field communication (NFC) circuit.

10. An operation method of an electronic device, for detecting an accessory device, the method comprising:
detecting a change of capacitance;
performing the authentication of the accessory device in response to the detected capacitance being a value exceeding a first threshold value; and
controlling screen data in response to a success of the authentication of the accessory device.

11. The method of claim 10, wherein performing the authentication of the accessory device comprises performing the authentication of the accessory device in response to the capacitance being a value between the first threshold value and a second threshold value having a value higher than the first threshold value.

12. The method of claim 11, wherein the first threshold value is a minimal value of capacitance for recognizing that a dielectric substance provided in the accessory device approaches or comes in contact with, and
the second threshold value is a minimal value of capacitance for recognizing that the human body approaches or comes in contact with.

13. The method of claim 10, wherein performing the authentication comprises identifying properties of a display region dependent on the type of the accessory device, and
the properties of the display region comprise at least one of a size, position, form and display scheme of the display region.

14. The method of claim 13, wherein controlling the screen data comprises at least one of:
displaying the screen data, based on the size, position, and form of the display region, wherein the screen data corresponds to the display region; and
changing the screen data, based on the display scheme of the display region, and displaying the changed screen data.

15. The method of claim 10, wherein performing the authentication of the accessory device further comprises performing the authentication of the accessory device in response to the detected capacitance being equal to or being greater than a second threshold value having a value higher than the first threshold value.

16. The device of claim 1, wherein the at least one threshold value comprises a first threshold value and a second threshold value, and
wherein the instructions cause the processor to:
execute a first action in response to the first signal including a value higher than the first threshold value and the second threshold value, and
execute a second action in response to the first signal including a value between the first threshold value and the second threshold value.

17. The device of claim 16, wherein:
the first action is an action of decreasing a strength of a signal transmitted to the external through the communication circuit, and
the second action is an action of forming a connection with the accessory device.

18. The device of claim 1, wherein the user interface comprises at least one of a display, a speaker, a vibration element, or a light emitting diode.

19. The method of claim 10, wherein the capacitance is detected by a sensor including a grip sensor, a touch sensor, a proximity sensor and an electrostatic/electric field detecting sensor provided in the electronic device.

20. The method of claim 11, wherein performing the authentication comprises:
activating the wireless communication circuit;
receiving identification information from the accessory device through the wireless communication circuit; and
identifying execution information corresponding to the received identification information.
